(19) United States
(12) Patent Application Publication
(10) Pub. No.: US 2008/0319664 A1
(43) Pub. Date: Dec. 25, 2008

(54) Navigation aid

(75) Inventors: Itzhak Kremin, Givatayim (IL); Shmuel Banitt, Beit Yanai (IL)

Correspondence Address: Ms. Ronny Fogel;Brux Software Solutions Ltd., 8 Gordon Street, Givatayim, 53235, IL

(73) Assignee: Tidex Systems Ltd.

(21) Appl. No.: 11/819,167

(22) Filed: Jun. 25, 2007

(51) Int. Cl. G01C 21/00; G06K 9/00

(52) U.S. Cl. 701/213; 382/100

(57) ABSTRACT

A method and apparatus for calculating exact positioning using a digital camera and a GPS, comprising calibrating the camera; initiating GPS navigation; capturing and storing images and GPS coordinates; calculating ego-motion of the camera using a pre-defined number of stored images; and calculating current position of the camera using the last stored GPS coordinates and the calculated camera ego-motion.

### FIELD OF THE INVENTION

The current invention is in the field of navigation and more specifically, navigation assistance using a monocular digital camera.

### BACKGROUND OF THE PRESENT INVENTION

Current global positioning system (GPS) based navigation systems are inherently limited in that the global position determined is actually the position of the associated receiver. The mounting location for the receiver must allow for a clear view of the GPS orbiting overhead. The GPS satellites may become unavailable to the GPS receiver for various periods of time in, for example, urban environments, when the GPS receiver travels under a bridge, through a tunnel, or through what is referred to in the literature as an “urban canyon,” in which buildings block the signals or produce excessively large multipath signals that make the satellite signals unfit for position calculations. In addition, operating the GPS receiver while passing through natural canyons and/or areas in which satellite coverage is sparse, may similarly result in the receiver being unable to track a sufficient number of satellites. Thus, in certain environments the navigation information may be available only sporadically, and GPS-based navigation systems may not be appropriate for use as a navigation tool. GPS signals may also be jammed or spoofed by hostile entities, and rendered useless as navigation aids.

One proposed solution to the problem of interrupted navigation information is to use an inertial system to fill-in whenever the GPS receiver cannot observe a sufficient number of satellites. The inertial system has well known problems, such as the derivation of the initial system (position, velocity and attitude) errors as well as IMU sensor errors that tend to introduce drifts into the inertial position information over time. It has thus been proposed to use the GPS position information to limit the adverse effects of the drift errors on the position calculations in the inertial system.

U.S. Pat. No. 6,721,657 to Ford et als. Discloses a receiver that uses a single processor to control a GPS sub-system and an inertial (“INS”) sub-system and, through software integration, shares GPS and INS position and covariance information between the sub-systems. The receiver time tags the INS measurement data using a counter that is slaved to GPS time, and the receiver then uses separate INS and GPS filters to produce GPS and INS position information that is synchronized in time. The GPS/INS receiver utilizes GPS position and associated covariance information in the updating of an INS Kalman filter, which provides updated system error information that is used in propagating inertial position, velocity and attitude. Whenever the receiver is stationary after initial movement, the INS sub-system performs “zero-velocity updates,” to more accurately compensate in the Kalman filter for component measurement biases and measurement noise. Further, if the receiver loses GPS satellite signals, the receiver utilizes the inertial position, velocity and covariance information provided by the Kalman filter in the GPS filters, to speed up GPS satellite signal re-acquisition and associated ambiguity resolution operations.

U.S. published Application No. 20070032950 to O'Flanagan et als. discloses a modular device, system and associated method, used to enhance the quality and output speed of any generic GPS engine. The modular device comprises an inertial subsystem based on a solid state gyroscope having a plurality of accelerometers and a plurality of angular rate sensors designed to measure linear acceleration and rotation rates around a plurality of axes. The modular inertial device may be placed in the data stream between a standard GPS receiver and a guidance device to enhance the accuracy and increase the frequency of positional solutions. Thus, the modular inertial device accepts standard GPS NMEA input messages from the source GPS receiver, corrects and enhances the GPS data using computed internal roll and pitch information, and produces an improved, more accurate, NMEA format GPS output at preferably 2 times the positional solution rate using GPS alone. The positional solution frequency using the present invention may increase to as much as 5 times that obtained using GPS alone. Moreover, the modular inertial device may assist when the GPS signal is lost for various reasons. If used without GPS, the modular inertial device may be used to define, and adjust, a vehicle's orientation on a relative basis. The modular inertial device and architecturally partitioned system incorporated into an existing GPS system may be applied to navigation generally, including high-precision land-based vehicle positioning, aerial photography, crop dusting, and sonar depth mapping to name a few applications.

There is need for a low-cost stand-alone navigation aid, easily mountable on any vehicle.

### SUMMARY OF THE INVENTION

According to a first aspect of the present invention, there is provided a navigation aid comprising: a processor comprising camera control, computation modules and a user interface control; a digital camera connected with the processor; and a GPS receiver connected with the processor, the processor adapted to receive positioning signals from the GPS receiver and pictures captured by the camera and calculate current position therefrom.

According to a first embodiment of this aspect the processor comprises a Personal Digital Assistant.

According to a second embodiment of this aspect the computation modules comprise a camera calibration module, camera ego-motion calculation module and camera current-position calculation module.

According to a third embodiment of this aspect the camera ego-motion calculation comprises calculating the optical flow of selected objects between at least two captured images.

According to a second aspect of the present invention there is provided a method of calculating exact positioning using a digital camera and a GPS, comprising the steps of: a. calibrating the camera; b. initiating GPS navigation; c. capturing and storing an image and GPS coordinates; d. repeating step (c) until navigation aid is requested; e. calculating ego-motion of the camera using a pre-defined number of stored images; and f. calculating current position of the camera using the last stored GPS coordinates and the calculated camera ego-motion.

According to a first embodiment of this aspect calculating the ego-motion comprises calculating the optical flow of selected objects between the pre-defined number of stored images.

According to a third aspect of the present invention there is provided a method of calculating exact positioning using a digital camera and a GPS, comprising the steps of: a. calibrating the camera; b. initiating GPS navigation; c. capturing and storing two images and a their respective GPS coordinates; d. calculating ego-motion of the camera using said two stored images; and e. calculating current position of the camera.

According to a first embodiment of this aspect calculating current position of the camera comprises using the Kalman Filter algorithm for integrating the GPS coordinates and the calculated camera ego-motion.

According to a second embodiment of this aspect the method additionally comprises, after step (e), the steps of: f. capturing and storing a new image and its respective GPS coordinates; g. calculating ego-motion of the camera using said stored new image and the last calculated camera ego-motion; h. calculating current position of the camera using the last calculated camera position and the newly calculated camera ego-motion; and i. optionally repeating steps (f) through (h).

According to a third embodiment of this aspect calculating current position of the camera comprises using the Kalman Filter algorithm for integrating the GPS coordinates and the calculated camera ego-motion.

According to a fourth aspect of the present invention there is provided a method of calculating exact positioning using a digital camera and reference coordinates, comprising the steps of: a. calibrating the camera; b. capturing and storing two images; c. calculating ego-motion of the camera using said two stored images; and d. calculating current position of the camera using the reference coordinates and the calculated camera ego-motion.

According to a first embodiment of this aspect the method additionally comprises, after step (d), the steps of: e. capturing and storing a new image; f. calculating ego-motion of the camera using said stored new image and the last calculated camera ego-motion; g. calculating current position of the camera using the last calculated camera position and the newly calculated camera ego-motion; and h. optionally repeating steps (e) through (g).

### BRIEF DESCRIPTION OF THE DRAWINGS

FIG. 1 is a general scheme of the system's functional architecture according to the present invention;

FIG. 2 is a schematic description of the system's components according to an embodiment of the present invention;

FIG. 3 is a flowchart describing the process of the present invention according to a first embodiment;

FIG. 4 is a flowchart describing the process of the present invention according to a second embodiment; and

FIG. 5 is a flowchart describing the process of the present invention according to a third embodiment.

### DETAILED DESCRIPTION OF PREFERRED EMBODIMENTS

The present invention provides a navigation aid, capable of ensuring continuous positioning information for a GPS assisted vehicle even when the GPS signal is temporarily obstructed or jammed.

In the following description, some embodiments of the present invention will be described as software programs. Those skilled in the art will readily recognize that the equivalent of such software can also be constructed in hardware. Because image manipulation algorithms and systems are well known, the present description will be directed in particular to algorithms and systems forming part of, or cooperating more directly with, the method in accordance with the present invention. Other aspects of such algorithms and systems, and hardware and/or software for producing and otherwise processing the image signals involved therewith, not specifically shown or described herein may be selected from such systems, algorithms, components, and elements known in the art. Given the description as set forth in the following specification, all software implementation thereof is conventional and within the ordinary skill in such arts.

The computer program for performing the method of the present invention may be stored in a computer readable storage medium. This medium may comprise, for example: magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program. The computer program for performing the method of the present invention may also be stored on computer readable storage medium that is connected to the image processor by way of a local or remote network or other communication medium. Those skilled in the art will readily recognize that the equivalent of such a computer program product may also be constructed in hardware or firmware known as application specific integrated circuits (ASICs).

An ASIC may be designed on a single silicon chip to perform the method of the present invention. The ASIC can include the circuits to perform the logic, microprocessors, and memory necessary to perform the method of the present invention. Multiple ASICs may be envisioned and employed as well for the present invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art.

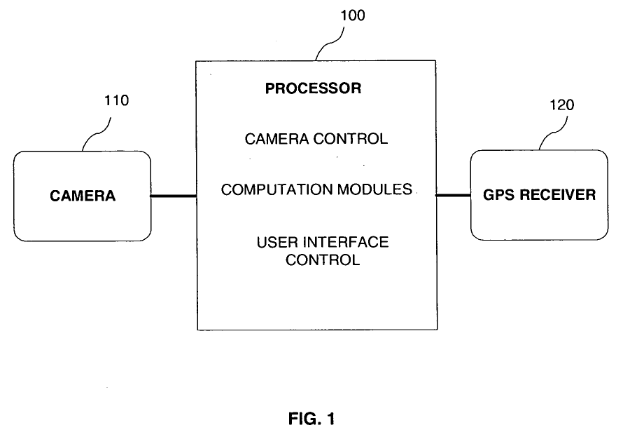

FIG. 1 is a general scheme of the system's functional architecture according to an embodiment of the present invention. The system comprises a processor 100, connected with a camera 110 and a GPS receiver 120.

According to one embodiment the processor 100 comprises a Personal Digital Assistant (PDA) including GPS receiver and software application and additionally comprising digital camera control and user interface functionality.

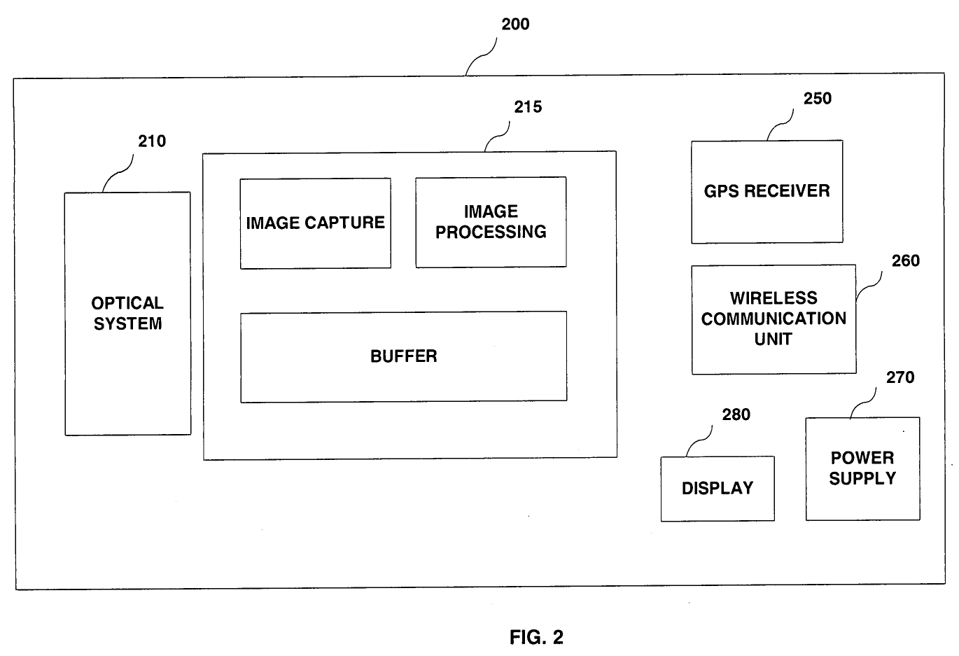

According to another embodiment, as depicted in FIG. 2, the processor 215, optical sensor 210, power supply 270, display 280 and wireless communication means 260 are packaged in a dedicated packaging 200. The packaging may additionally comprise a GPS receiver 250, or communicate wirelessly with an external GPS receiver. Packaging 200 may be installed at any suitable location on the vehicle.

The wireless communication means 260 may be any means known in the art, such as Cellular: CDMA, GSM, TDMA, Local area networks: 802.11b, 802.11a, 802.11h, HyperLAN, Bluetooth, HOMEPNA, etc.

The optical system 210 may be a gray-level or color CMOS or CCD camera, examples of which are JVC HD111 E, Panasonic AG-HVX 200, Panasonic DVX 100, Sony HVR-V1P.

The processor 215 is preferably an off-the-shelf electronic signal processor, of the type of a DSP or alternatively an FPGA. The choice of processor hardware may be related to the choice of camera, its output rate, frame size, frame rate, pixel depth, signal to noise etc. Examples of suitable DSP type processors are Blackfin, Motorola 56800E and TI-TMS320VC5510. Another example is a CPU type processor such as Motorola: Dragon Ball-MX1 (ARM9), Motorola: Power PC-PowerQuicc 74xx (Dual RISC), or Hitachi SH3 7705.

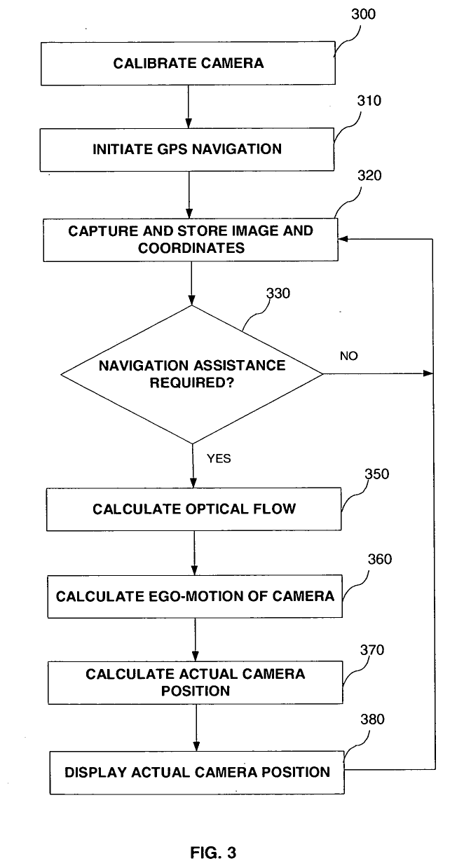

FIG. 3 is a flowchart describing the various steps involved in implementing the process of the present invention according to a first embodiment.

Step 300 is a preparatory step of calibrating the camera and lens. The calibration process measures camera and lens parameters such as focal length, lens astigmatism and other irregularities of the camera. These measurements are later used to correct the optical sensor's readouts. The calibration may be done using any method known in the art for calibrating digital camera lens distortions. According to one embodiment, the camera calibration uses the Flexible Camera Calibration Technique, as published in:
Z. Zhang. A flexible new technique for camera calibration. IEEE Transactions on Pattern Analysis and Machine Intelligence, 22(11):1330-1334, 2000.
Z. Zhang. Flexible Camera Calibration By Viewing a Plane From Unknown Orientations. International Conference on Computer Vision (ICCV'99), Corfu, Greece, pages 666-673, September 1999.
   Both publications are incorporated herein by reference.

According to the Flexible Camera Calibration Technique, the camera observes a planar pattern shown at a few (at least two) different orientations. Either the camera or the planar pattern can be freely moved. The motion need not be known. Radial lens distortion is modeled. The procedure consists of a closed-form solution, followed by a nonlinear refinement based on the maximum likelihood criterion.

According to another embodiment, the camera calibration uses the Fully Automatic Camera Calibration Using Self-identifying Calibration Targets technique, as published in:

### Fiala, M., Shu, C., Fully Automatic Camera Calibration Using Self-Identifying Calibration Targets, NRC/ERB-1130. November 2005, NRC 48306.

The publication is incorporated herein by reference.

According to the Fully Automatic Camera Calibration Using Self-identifying Calibration Targets technique, the camera is allowed to be calibrated merely by passing it in front of a panel of self-identifying patterns. This calibration scheme uses an array of ARTag fiducial markers which are detected with a high degree of confidence, each detected marker provides one or four correspondence points. The user prints out the ARTag array and moves the camera relative to the pattern, the set of correspondences is automatically determined for each camera frame, and input to the calibration code.

In step 310, GPS navigation is initiated, for example by turning on the GPS device and/or defining a route or an end-point, as is known in the art.

The vehicle now actually starts its journey, using GPS navigation and preparing for the event of GPS failure for any of the reasons enumerated above.

In step 320, a first image is captured by the camera, optionally corrected with reference to the calibration step 300 and stored in buffer 240 along with the last received GPS coordinates.

In step 330, the processor checks whether navigation assistance is required. According to one embodiment, a time-delay greater than a predefined threshold since the last received GPS signal may serve for automatically raising an “assistance required” system flag. According to another embodiment, the user may manually request assistance using the user interface.

If no navigation assistance is required, the process goes back to step 320 to capture an additional picture.

The number of pictures stored in buffer 240 may be limited by the buffer size. Since the computational algorithms which will be described below require a plurality of images, say N, a suitable mechanism may be devised for saving the N last captured pictures in a cyclic buffer handling method, or alternatively, the required buffer size may be dictated by the memory space required for storing N images.

If in step 330 it was decided that navigation assistance is required, the system proceeds to step 350, in which the optical flow for the last N captured images is calculated. In an image, each pixel corresponds to the intensity value obtained by the projection of an object in 3-D space onto the image plane. When the objects move relative to the camera, their corresponding projections also change position in the image plane. Optical flow is a vector field that shows the direction and magnitude of these intensity changes from one image to the other. The software analyzes the consecutive frames and searches for points which are seen clearly over their background, such as but not limited to points with high gray-level or color gradient. A check of the robustness and reliability of the chosen points may then be made, by running the search algorithm backwards and determining whether the points found in adjacent frames generate the original starting points. For each chosen point, the software registers the 2D location in each frame that contains it. The collective behavior of all these points comprises the optical flow.

In step 350, the calculated optical flow serves for calculating the camera ego-motion, namely, the camera displacement.

One method of calculating ego-motion is described in:

Boyoon Jung and Gaurav S. Sukhatme, Detecting Moving Objects using a Single Camera on a Mobile Robot in an Outdoor Environment, 8^{th} Conference on Intelligent Autonomous Systems, pp. 980-987, Amsterdam, The Netherlands, Mar. 19-13, 2004, said publication incorporated herein by reference.

According to this method, once the correspondence between chosen points in different frames is known, the ego-motion of the camera can be estimated using a transformation model and an optimization method. The transformation model may be an affine model, a bilinear model or a pseudo-perspective model, and the optimization method may be the least square optimization.

According to another embodiment, the camera ego-motion may be calculated using the technique described in:

Justin Domke and Yanis Aloimonos, A Probabilistic Notion of Correspondence and the Epipolar Constraint, Dept. of Computer Science, University of Maryland,

http://www.cs.umd.edu/users/domke/papers/20063dpvt.pdf, said publication incorporated herein by reference.

According to this method, instead of computing optic flow or correspondence between points, a probability distribution of the flow is computed.

In step 370, the actual camera position is calculated, given the information regarding real-world coordinates of a frame F, preceding the last saved frame L and the ego-motion of the camera between frames F and L.

In step 380 the absolute camera location may be displayed to the user, preferably in conjunction with a navigation map.

According to a second embodiment of the present invention, the navigation aid may be used continuously and may serve as an additional means for accurate positioning along with a working global or local positioning device, preferably using the Kalman Filter algorithm for integrating the two data streams.

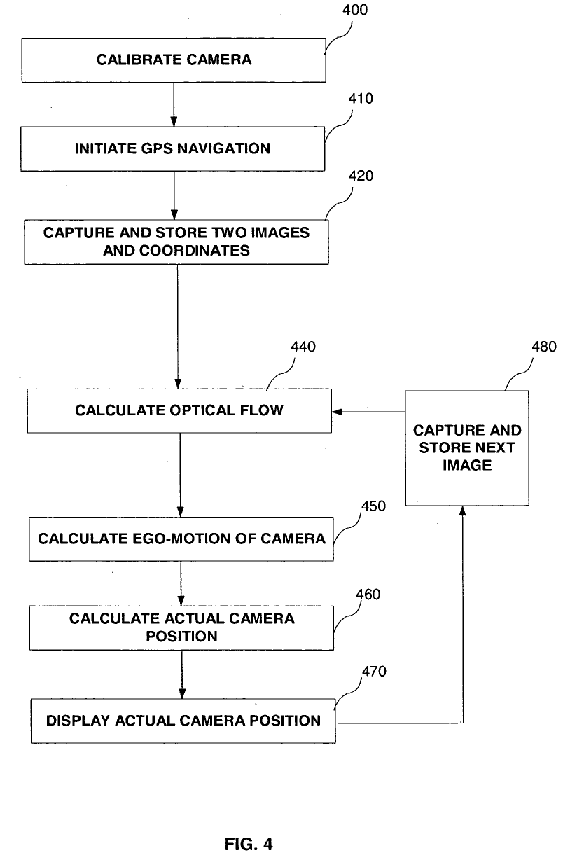

FIG. 4 is a flowchart describing the various steps involved in implementing the process of the present invention according to the second embodiment.

Steps 400 and 410 are similar to steps 300 and 310 of FIG. 3.

In step 420, two images are captured by the camera, optionally corrected with reference to the calibration step 400 and stored in buffer 240 along with their respective time-stamps. According to this second embodiment, the size of buffer 240 should only be sufficient for storing two captured images, as will be apparent from the explanation below.

In step 440, the optical flow is calculated in any of the methods described above in conjunction with FIG. 3. In this second embodiment, the first optical flow calculation uses the first two captured images. As additional images are being captured, the optical flow is re-calculated, using the results of the latest calculation with the additional data of the last captured image.

Steps 450 through 470 are similar to steps 360 through 380 of FIG. 3.

In step 480, at least one additional image is captured, its GPS coordinates saved and a new optical flow is calculated (step 440) as described above.

According to a third embodiment of the present invention, the navigation aid may function independent of any other global or local positioning device, for example as an orientation aid in a mine.

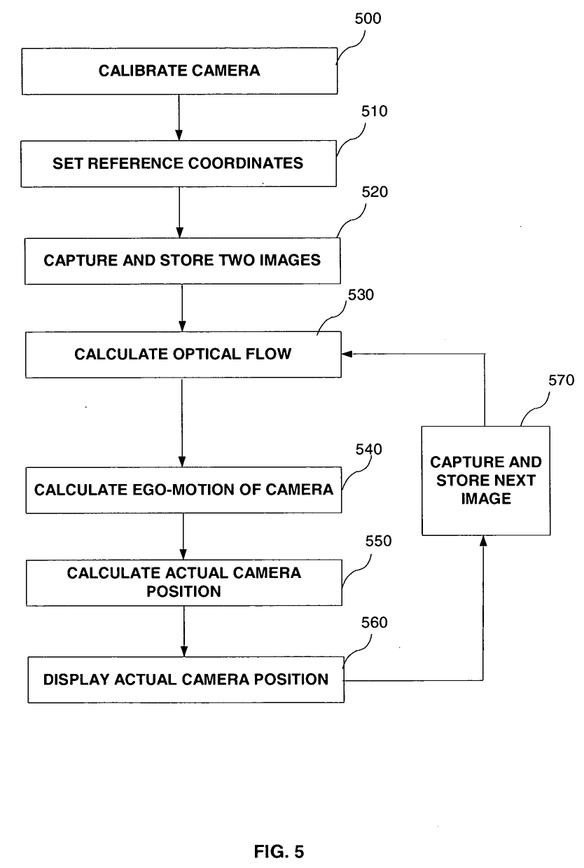

FIG. 5 is a flowchart describing the various steps involved in implementing the process of the present invention according to the third embodiment.

The steps are similar to those discussed in conjunction with FIG. 4, except that no GPS is required. Instead, initial reference coordinates, global or local, are set in step 510, to serve as reference for the subsequent relative positions calculated by the navigation aid.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof which would occur to persons skilled in the art upon reading the foregoing description.

1. Navigation aid comprising:
a processor comprising camera control, computation modules and a user interface control;
a digital camera connected with said processor; and
a GPS receiver connected with said processor,
said processor adapted to receive positioning signals from said GPS receiver and pictures captured by said camera and calculate current position therefrom.

2. The navigation aid according to claim 1, wherein said processor comprises a Personal Digital Assistant.

3. The navigation aid according to claim 1, wherein said computation modules comprise a camera calibration module, camera ego-motion calculation module and camera current-position calculation module.

4. The navigation aid according to claim 3, wherein said camera ego-motion calculation comprises calculating the optical flow of selected objects between at least two captured images.

5. A method of calculating exact positioning using a digital camera and a GPS, comprising the steps of:
a. calibrating the camera;
b. initiating GPS navigation;
c. capturing and storing an image and GPS coordinates;
d. repeating step (c) until navigation aid is requested;
e. calculating ego-motion of the camera using a pre-defined number of stored images; and
f. calculating current position of the camera using the last stored GPS coordinates and the calculated camera ego-motion.

6. The method according to claim 5, wherein said calculating the ego-motion comprises calculating the optical flow of selected objects between said pre-defined number of stored images.

7. A method of calculating exact positioning using a digital camera and a GPS, comprising the steps of:
a. calibrating the camera;
b. initiating GPS navigation;
c. capturing and storing two images and a their respective GPS coordinates;
d. calculating ego-motion of the camera using said two stored images; and
e. calculating current position of the camera.

8. The method according to claim 7, wherein said calculating current position of the camera comprises using the Kalman Filter algorithm for integrating the GPS coordinates and the calculated camera ego-motion.

9. The method according to claim 7, additionally comprising, after step (e), the steps of:
f. capturing and storing a new image and its respective GPS coordinates;
g. calculating ego-motion of the camera using said stored new image and the last calculated camera ego-motion;
h. calculating current position of the camera using the last calculated camera position and the newly calculated camera ego-motion; and
i. optionally repeating steps (f) through (h).

10. The method according to claim 9, said calculating current position of the camera comprises using the Kalman Filter algorithm for integrating the GPS coordinates and the calculated camera ego-motion.

11. A method of calculating exact positioning using a digital camera and reference coordinates, comprising the steps of:
a. calibrating the camera;
b. capturing and storing two images;
c. calculating ego-motion of the camera using said two stored images; and
d. calculating current position of the camera using the reference coordinates and the calculated camera ego-motion.

12. The method according to claim 11, additionally comprising, after step (d), the steps of:
e. capturing and storing a new image;
f. calculating ego-motion of the camera using said stored new image and the last calculated camera ego-motion;
g. calculating current position of the camera using the last calculated camera position and the newly calculated camera ego-motion; and
h. optionally repeating steps (e) through (g).
